(19) United States
(12) Patent Application Publication
(10) Pub. No.: US 2017/0263127 A1
(43) Pub. Date: Sep. 14, 2017

(54) VEHICLE COLLISION SYSTEM AND METHOD OF USING THE SAME

(71) Applicant: GM GLOBAL TECHNOLOGY OPERATIONS LLC, Detroit, MI (US)

(72) Inventors: Joshua R. Auden, Brighton, MI (US); Mohamed M. Nasser, Dearborn, MI (US); Jerry D. Green, Ortonville, MI (US); Steve K. Dobos, Lapeer, MI (US); Fred W. Huntzicker, Ann Arbor, MI (US)

(21) Appl. No.: 15/063,721

(22) Filed: Mar. 8, 2016

(51) Int. Cl. G08G 1/16

(52) U.S. Cl. CPC G08G 1/166

(57) ABSTRACT

A method is provided for use with a vehicle collision system. The method includes detecting one or more object(s) in a host vehicle's field-of-view, calculating time-to-pass estimates for each of the detected object(s), wherein the time-to-pass estimates represent an expected time for a reference plane of the host vehicle to pass a reference plane of the detected object(s), and determining a potential collision between the host vehicle and the one or more detected object(s) based on the time-to-pass estimates.

### FIELD

The present invention generally relates to vehicle collision systems, and more particularly, to a vehicle collision system configured to detect and mitigate collisions.

### BACKGROUND

Traditional vehicle collision systems are used to warn or otherwise alert a driver of a potential collision with an object or another vehicle. However, these warning systems are typically limited to other vehicles or objects in a forward or reverse host vehicle trajectory. Objects or other vehicles that pose a collision threat to the sides of a vehicle are generally more difficult to detect.

### SUMMARY

According to an embodiment of the invention, there is provided a method for use with a vehicle collision system. The method includes detecting one or more object(s) in a host vehicle's field-of-view, calculating time-to-pass estimates for each of the detected object(s), wherein the time-to-pass estimates represent an expected time for a reference plane of the host vehicle to pass a reference plane of the detected object(s), and determining a potential collision between the host vehicle and the one or more detected object(s) based on the time-to-pass estimates.

According to another embodiment of the invention, there is provided a method for use with a vehicle collision system that includes detecting at least one object in a host vehicle's field-of-view, calculating an expected host vehicle path relative to the at least one detected object, and determining a potential for a collision between the at least one detected object and a front, rear, left-side, or right-side of the host vehicle, wherein the potential for collision is based on the expected host vehicle path and an intersection of reference planes relating to the host vehicle and the at least one detected object.

According to yet another embodiment of the invention, there is provided a vehicle collision system having a plurality of sensors configured to identify one or more objects in a host vehicle's field-of-view, and a control module configured to calculate time-to-pass estimates for each of the detected object(s), wherein the time-to-pass estimates represent an expected time for a reference plane of the host vehicle to pass a reference plane of the detected object(s), and determine a potential collision between the host vehicle and the one or more detected object(s) based on the time-to-pass estimates.

### DRAWINGS

One or more embodiments of the invention will hereinafter be described in conjunction with the appended drawings, wherein like designations denote like elements, and wherein:

FIG. 1 is a is a schematic view illustrating a host vehicle having an exemplary vehicle collision system; and

FIG. 2 is a schematic view illustrating representations of potential side collisions with another vehicle and with stationary objects;

FIG. 3 is another schematic view illustrating representations of potential side collisions with stationary objects in a parking scenario;

FIG. 4 an exemplary module architecture configuration that may be used to implement vehicle collision system 10 shown in FIG. 1;

FIG. 5 is a flowchart illustrating an exemplary method for use with a vehicle collision warning system, such as the exemplary system shown in FIG. 1;

FIG. 6 is a flowchart illustrating an exemplary method for determining a potential collision for use with a vehicle collision warning system, such as the exemplary system shown in FIG. 1;

FIG. 7 illustrates an exemplary representation of the reference planes associated with the method for determining a potential collision, such as the exemplary method shown in FIG. 6; and

FIG. 8 illustrates another exemplary representation of the reference planes associated with the method for determining a potential collision, such as the exemplary method shown in FIG. 6.

### DESCRIPTION

The exemplary vehicle collision system and method described herein may be used to detect and avoid potential or impending collisions with stationary or moving objects, and in particular, a side collision at relatively low speed and/or parking scenarios. For purposes of the present application, the term “low speed” means vehicle speeds of 30 mph or less. The disclosed vehicle collision system implements a method for detecting objects around a periphery of the vehicle and determines whether there is a potential for collision based on the vehicle's trajectory and position of the detected objects. In one embodiment, determining potential collisions with the detected objects includes determining a type of potential collision and calculating a corresponding time-to-collision. Based on this information, the system then determines which of the detected objects poses the highest threat, which in one embodiment may take into account the time-to-collision and the type of potential collision. The highest threat object is then compared to a plurality of thresholds to determine the most appropriate remedial action to avoid or mitigate the collision.

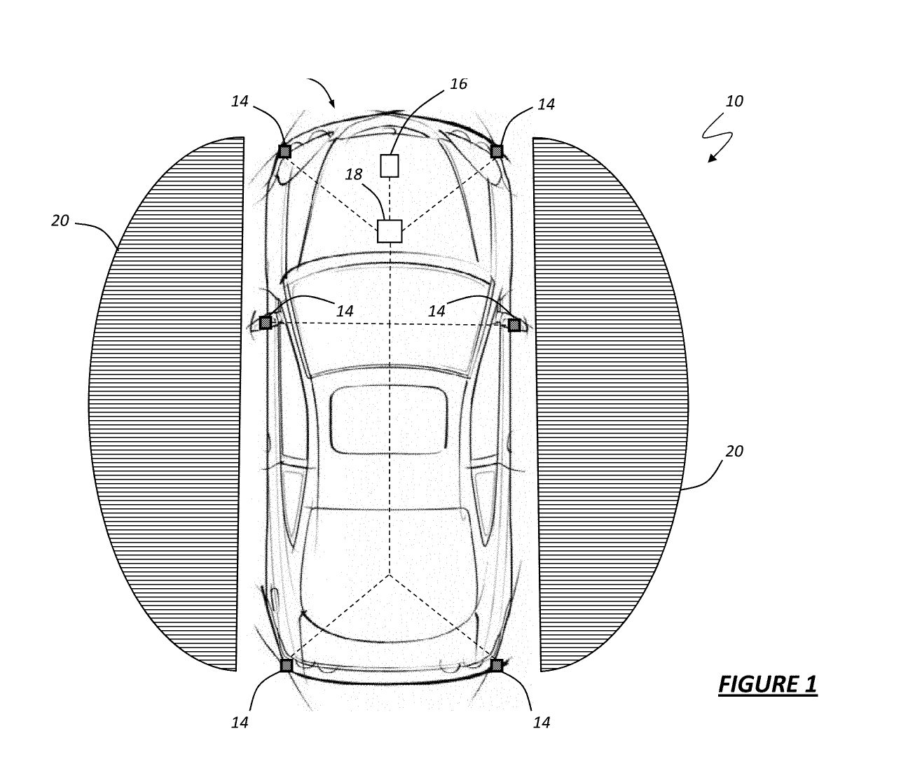

With reference to FIG. 1, there is shown a general and schematic view of an exemplary vehicle collision system 10 installed on a host vehicle 12. It should be appreciated that the present system and method may be used with any type of vehicle, including traditional vehicles, hybrid electric vehicles (HEVs), extended-range electric vehicles (EREVs), battery electrical vehicles (BEVs), motorcycles, passenger vehicles, sports utility vehicles (SUVs), cross-over vehicles, trucks, vans, buses, recreational vehicles (RVs), etc. These are merely some of the possible applications, as the system and method described herein are not limited to the exemplary embodiments shown in the Figures, and could be implemented in any number of different ways.

According to one example, vehicle collision system 10 employs object detection sensors 14, inertial measurement unit (IMU) 16, and a control module 18, which in one embodiment is an external object calculating module (EOCM). Object detection sensors 14 may be a single sensor or a combination of sensors, and may include without limitation, a light detection and ranging (LIDAR) device, a radio detection and ranging (RADAR) device, a vision device (e.g., camera, etc.), a laser diode pointer, or a combination thereof. Object detection sensors 14 may be used alone, or in conjunction with other sensors, to generate readings that represent an estimated position, velocity and/or acceleration of the detected objects with respect to the host vehicle 12. These readings may be absolute in nature (e.g., a velocity or acceleration of the detected object that is relative to ground) or they may be relative in nature (e.g., a relative velocity reading (Av) which is the difference between the detected object and host vehicle velocities, or a relative acceleration reading (Aa) which is the difference between the detected object and host vehicle accelerations). Collision system 10 is not limited to any particular type of sensor or sensor arrangement, specific technique for gathering or processing sensor readings, or particular method for providing sensor readings, as the embodiments described herein are simply meant to be exemplary.

Any number of different sensors, components, devices, modules, systems, etc. may provide vehicle collision warning system 10 with information or input that can be used by the present method. It should be appreciated that object detection sensors 14, as well as any other sensor located in and/or used by collision system 10 may be embodied in hardware, software, firmware, or some combination thereof. These sensors may directly sense or measure the conditions for which they are provided, or they may indirectly evaluate such conditions based on information provided by other sensors, components, devices, modules, systems, etc. Furthermore, these sensors may be directly coupled to control module 18, indirectly coupled via other electronic devices, a vehicle communications bus, network, etc., or coupled according to some other arrangement known in the art. These sensors may be integrated within another vehicle component, device, module, system, etc. (e.g., sensors integrated within an engine control module (ECM), traction control system (TCS), electronic stability control (ESC) system, antilock brake system (ABS), etc.), or they may be stand-alone components (as schematically shown in FIG. 1). It is possible for any of the various sensor readings to be provided by some other component, device, module, system, etc. in vehicle 12 instead of being directly provided by an actual sensor element. In some instances, multiple sensors might be employed to sense a single parameter (e.g., for providing signal redundancy). It should be appreciated that the foregoing scenarios represent only some of the possibilities, as any type of suitable sensor arrangement may be used by collision system 10.

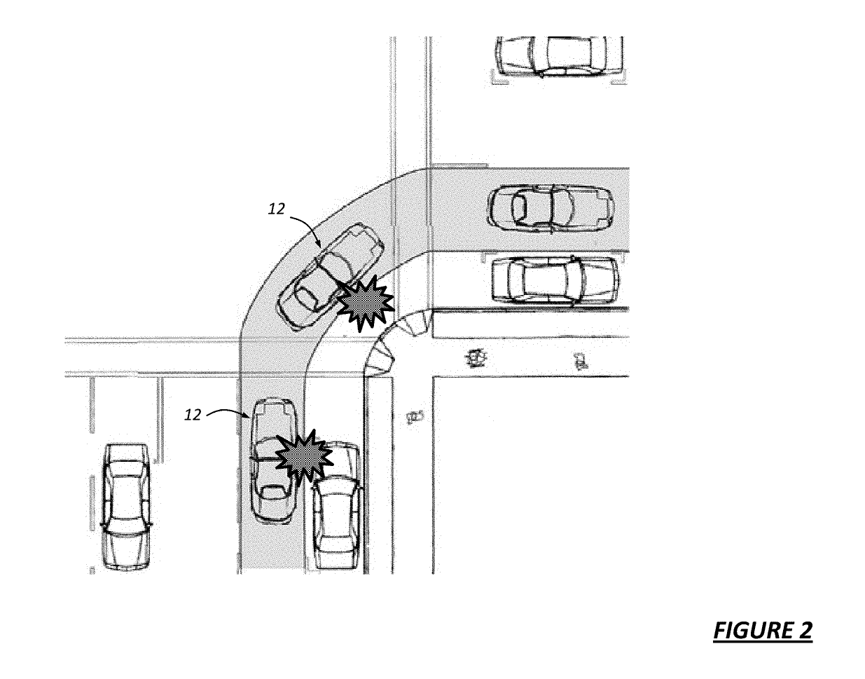

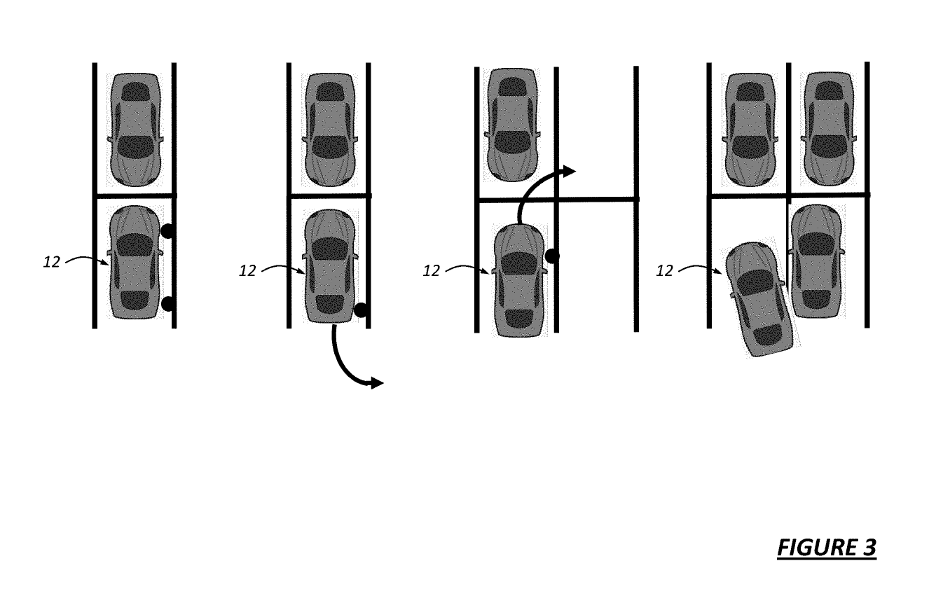

As shown in FIG. 1, object detection sensors 14 may be located in the side-vehicle mirrors, front vehicle bumpers, and/or rear vehicle bumpers. While not shown, object detection sensors 14 may also be placed in the vehicle doors. One of ordinary skill in the art appreciates that while six object detection sensors 14 are illustrated in FIG. 1, the number of sensors required may vary depending on the type of sensor and vehicle. Regardless of the position or the number of sensors used, object detection sensors 14 are calibratable and configured to create a field-of-view 20 that extends from a front end of the vehicle to a back end of the vehicle and outwardly from each side of the vehicle 12. In this way, vehicle collision system 10 is able to detect and prevent side collisions with various objects as shown in FIGS. 2 and 3. For example, FIG. 2 illustrates graphical representations of potential side collisions with another vehicle and with stationary objects such as curbs, fire hydrants, pedestrians, poles, etc. as the host vehicle 12 is turning a corner. Similarly, FIG. 3 illustrates examples of potential side collisions in low speed parking scenarios wherein the host vehicle 12 is backing out of, or otherwise maneuvering, out of a parking stall. The term “objects” should be broadly construed to include any objects that are detectable in the field-of-view 20, including other vehicles. For purposes of illustration, the field-of-view 20 in FIG. 1 is shown primarily extending along the sides of host vehicle 12. However, one of ordinary skill in the art appreciates that typical object detection and tracking systems are implemented on all sides of the host vehicle 12 in various combinations such that objects may be detected and tracked 360 degrees around the vehicle 12.

IMU 16 is an electronic device that measures and reports a vehicle's velocity, orientation, and gravitational forces using a combination of accelerometers, gyroscopes, and/or magnetometers. IMU 16 works by detecting a current rate of acceleration using one or more accelerometers and detects changes in rotational attributes like pitch, roll, and yaw using one or more gyroscopes. Some also include a magnetometer, mostly to assist calibration against orientation drift. Angular accelerometers measure how the vehicle is rotating in space. Generally, there is at least one sensor for each of the three axes: pitch (nose up and down), yaw (nose left and right) and roll (clockwise or counter-clockwise from the vehicle cockpit). Linear accelerometers measure non-gravitational accelerations of the vehicle. Since it can move in three axes (up & down, left & right, forward & back), there is a linear accelerometer for each axis. A computer continually calculates the vehicle's current position. First, for each of the six degrees of freedom (x,y,z and θₓ, θ_{y} and θ_{z}), it integrates over time the sensed acceleration, together with an estimate of gravity, to calculate the current velocity. Then it integrates the velocity to calculate the current position.

Control module 18 may include any variety of electronic processing devices, memory devices, input/output (I/O) devices, and/or other known components, and may perform various control and/or communication related functions. Depending on the particular embodiment, control module 18 may be a stand-alone vehicle electronic module (e.g., an object detection controller, a safety controller, etc.), it may be incorporated or included within another vehicle electronic module (e.g., a park assist control module, brake control module, etc.), or it may be part of a larger network or system (e.g., a traction control system (TCS), electronic stability control (ESC) system, antilock brake system (ABS), driver assistance system, adaptive cruise control system, lane departure warning system, etc.), to name a few possibilities. Control module 18 is not limited to any one particular embodiment or arrangement.

For example, in an exemplary embodiment control module 18 is an external object calculating module (EOCM) that includes an electronic memory device that stores various sensor readings (e.g., inputs from object detection sensors 14 and position, velocity, and/or acceleration readings from IMU 16), look up tables or other data structures, algorithms, etc. The memory device may also store pertinent characteristics and background information pertaining to vehicle 12, such as information relating to stopping distances, deceleration limits, temperature limits, moisture or precipitation limits, driving habits or other driver behavioral data, etc. EOCM 18 may also include an electronic processing device (e.g., a microprocessor, a microcontroller, an application specific integrated circuit (ASIC), etc.) that executes instructions for software, firmware, programs, algorithms, scripts, etc. that are stored in the memory device and may govern the processes and methods described herein. EOCM 18 may be electronically connected to other vehicle devices, modules and systems via suitable vehicle communications and can interact with them when required. These are, of course, only some of the possible arrangements, functions and capabilities of EOCM 18, as other embodiments could also be used.

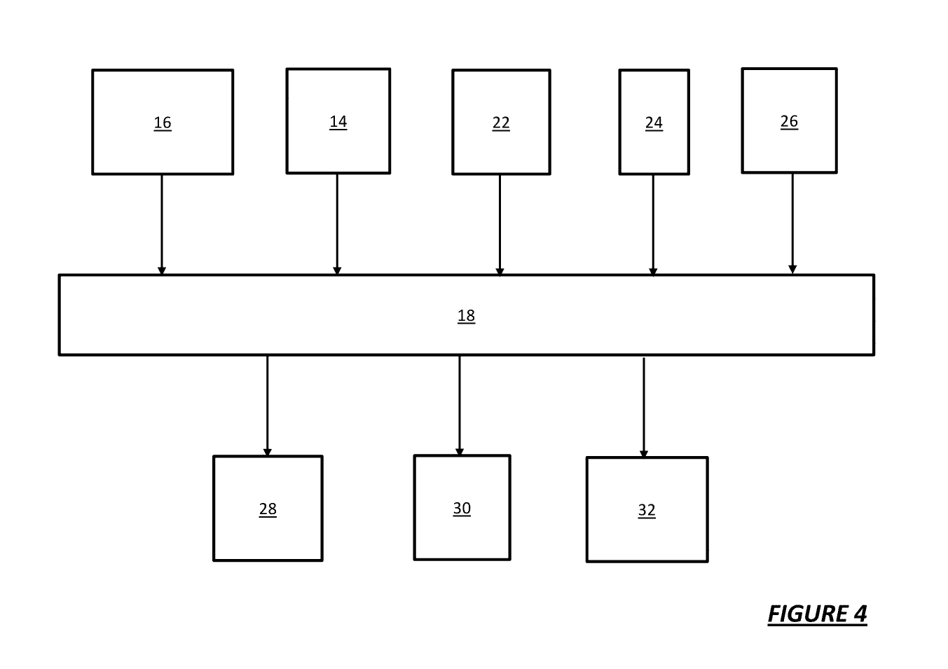

FIG. 4 illustrates an exemplary module architecture configuration that may be used to implement vehicle collision system 10 shown in FIG. 1. As set forth above, in an exemplary embodiment control module 18 is an EOCM having a plurality of inputs and outputs that are used to implement the disclosed method for detecting and mitigating side vehicle collisions. In addition to receiving inputs from object detection sensors 14 and IMU 16 as discussed above, EOCM 18 is also configured to receive data from sensors related to the position of the throttle pedal 22, the position of the brake pedal 24, and the angle of the steering wheel 26. The EOCM 18 uses these inputs to determine whether a collision with objects detected in the vehicle's field-of-view at relatively low speeds is possible, and how to avoid or mitigate the collision. The EOCM 18 is further configured to communicate with and send commands to various other vehicle components including an electronic brake control module 28, an electric power steering module 30, and an instrument panel cluster 32. As set forth in greater detail below, the EOCM 18 is configured detect a potential collision with an object at relatively low speeds, and in particular, potential collisions with the side surface of the vehicle 12, and to mitigate the potential for such a collision by selectively controlling one or more of vehicle steering through the electric power steering module 30, vehicle braking through the electronic brake control module 28, and by initiating warnings to the vehicle occupants through the instrument panel cluster 32.

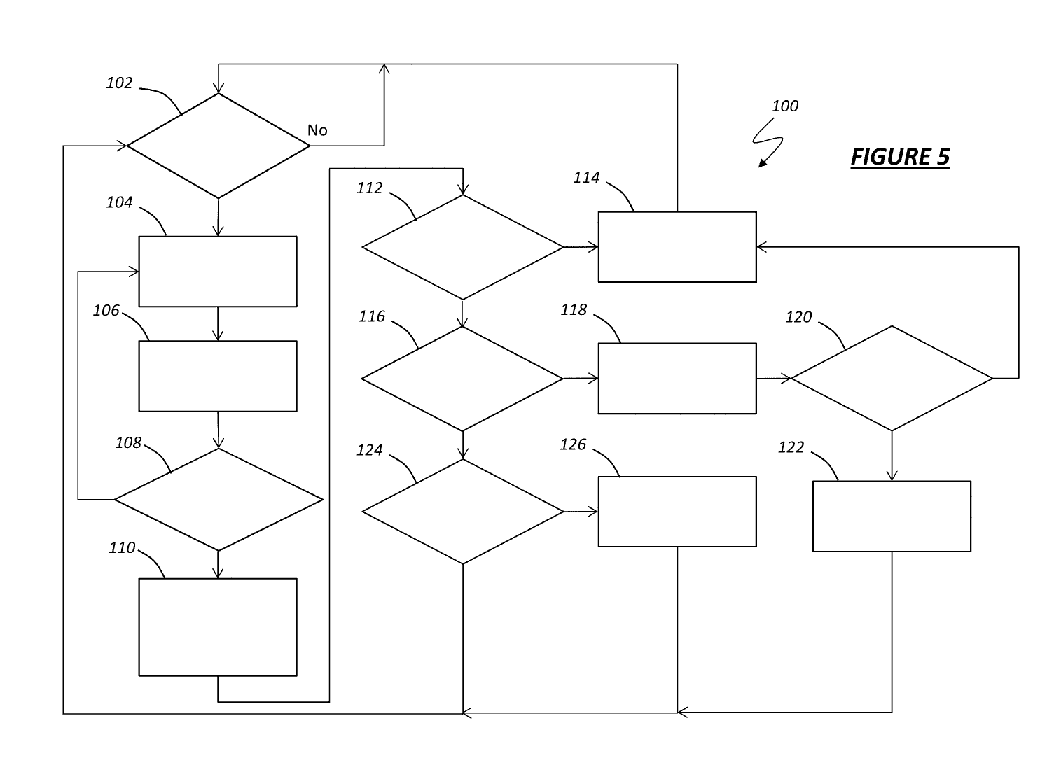

Turning now to FIG. 5, there is shown an exemplary method 100 that may be used with vehicle collision system 10 to detect and avoid potential or impending collisions with an object or other vehicle. Beginning with step 102, the system 10 determines whether the collision system 10 is enabled. The enablement of the collision system 10 depends on varying criteria, including, but not limited to, the vehicle ignition being in an “on” position. At step 104 the system via EOCM 18 references sensor data from at least object detection sensors 14 to determine if objects or other vehicles are detected within the field-of-view 20 of the host vehicle 12. According to one particular embodiment, step 104 receives sensor data relating to a relative velocity reading (Δv) that is representative of the difference between an object and host vehicle velocities, an object acceleration reading (a_{OBJ}), and a relative distance reading (Δd) that is representative of the range or distance between the object and the host vehicle 12. Some other examples of potential readings that may be gathered in step 104 include an object velocity reading (v_{OBJ}), a host vehicle velocity reading (v_{HOST}), a host vehicle acceleration reading (a_{HOST}), and a relative acceleration reading (Δa) that is representative of the difference between the object and host vehicle accelerations.

At step 106, the vehicle's expected path is calculated based on data received from various vehicle components, such as, for example, the IMU 16, the throttle pedal sensor, the brake pedal sensor, and the steering wheel angle sensor. At step 108, preliminary assessments are made to determine the potential for collisions with the detected objects using the vehicle's expected path and the sensor data. In one embodiment, the assessments include course estimates regarding the vehicle's expected path and the current position of the detected objects. Based on these course estimates, the system determines whether a potential for a collision exists between the host vehicle 12 and the detected objects. If there is no potential for a collision with any of the detected objects, the process returns to referencing the sensor data at step 104. If there is a potential for a collision with one or more detected objects, at step 110 the system initiates a preliminary threat assessment, which includes determining a time-to-collision for each potential collision. The system determines which of the detected objects poses the highest threat and calculates a final time-to-collision between the host vehicle 12 and the highest threat object. In one embodiment, the highest threat object is the object having the lowest time-to-collision. In words, the first object that is likely to collide with the host vehicle 12 based on the relationship between the position, movement, and trajectory of both the vehicle 12 and the detected object. In other embodiments, the highest threat object is determined based on a combination of the time-to-collision and the type of collision.

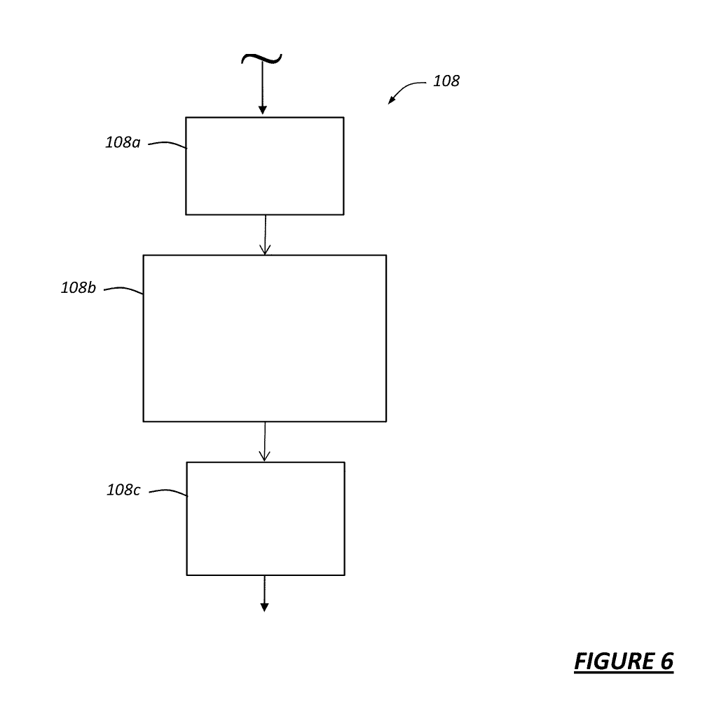

In one particular embodiment of step 108, the collision assessment includes determining whether there is a potential for collision between the host vehicle 12 and the detected objects, and also, the type of potential collision. An exemplary method for implementing the collision assessment of step 108 is described below with reference to the flow chart illustrated in FIG. 6. The collision assessment begins at step 108a, by calculating for each of the detected objects, time-to-pass (TTP) estimates relative to the front, rear, and side surfaces of the host vehicle 12. The TTP estimates generally refer to an expected time for one reference plane to pass (or clear) another, and in particular, an expected time for a reference plane for host vehicle 12 to cross a reference plane of a detected object. The TTP estimates may be calculated using known techniques such as extrapolation and regression methods using the sensor data retrieved at step 104 and the projected host vehicle path calculated at step 106. In one embodiment, the TTP estimates may be calculated based on the relative speed and distance between the host vehicle 12 and the detected objects. One of ordinary skill in the art appreciates that in some instances, the TTP estimate calculations include assumptions regarding the dimensions of the detected objects. In particular, the distance between parallel reference planes.

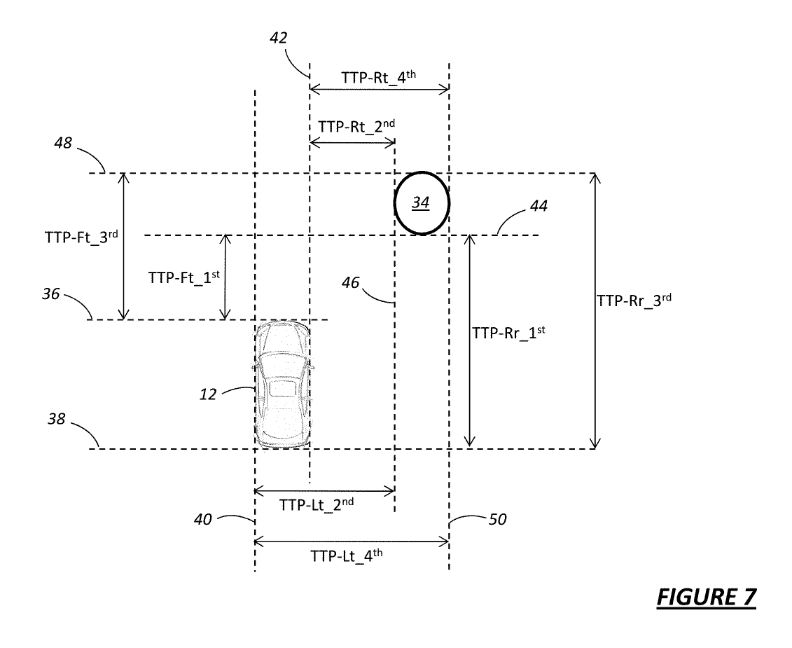

An exemplary visual representation of the TTP estimates is shown in FIG. 7. For ease of explanation, FIG. 7 illustrates only one detected object 34 represented generically as a circle. One skilled in the art appreciates that in practice, there is generally more than one object detected in the host vehicle's field-of-view and that the collision assessment method of step 108 is applied to each detected object. Referring to FIG. 7, the host vehicle 12 and the detected object 34 each have four planes of reference from which the TTP estimates are calculated. One of ordinary skill in the art recognizes that each plane of reference refers generally to a two-dimensional plane representing each peripheral surface of the host vehicle 12 and the detected object 34. For example, the host vehicle 12 reference planes include a front plane 36, a rear plane 38, a left-side plane 40, and a right-side plane 42. The detected object 34 reference planes include a first-surface plane 44, a second-surface plane 46, a third-surface plane 48, and a fourth-surface plane 50. In this embodiment, the front and rear planes 36, 38 of the host vehicle 12 are parallel to the first-surface and third-surface planes 44, 48 of the detected object 34. Likewise, the left-side 40, and right-side planes 42 of the host vehicle 12 are parallel to the second-surface and fourth-surface planes 46, 50 of the detected object 34. It should be noted that the surface planes of the detected objects may or may not correspond to physical planes of the object itself—as shown in the diagram, the object may be round or have a physical plane that is not parallel. Moreover, for the particular embodiments disclosed herein, assume that the first-surface plane 44 of the detected object is the nearest parallel plane to the front and/or rear of the host vehicle, the third-surface plane 48 of the detected object is the furthest parallel plane to the front and/or rear of the host vehicle, the second-surface plane 46 of the detected object is the nearest parallel plane to the left and/or right side of the host vehicle, and the fourth-surface plane 50 of the detected object is the furthest parallel plane to the left and/or right side of the host vehicle.

The TTP estimates are calculated for parallel reference planes between the host vehicle 12 and the detected object 34. In other words, TTP estimates are calculated between the front and rear planes 36, 38 of the host vehicle 12 to each of the first-surface and third-surface planes 44, 48 of the detected object 34, and between the left-side and right-side planes 40, 42 of the host vehicle 12 to each of the second-surface and fourth-surface planes 46, 50 of the detected object 34. The TTP estimates for each of these parallel planes are shown in FIG. 7, namely, TTP-Ft_1^{st} TTP-Ft_3^{rd}, TTP-Rr_1^{st}, TTP-Rr_3^{rd} TTP-Lt_2^{nd} TTP-Lt_4^{th}, TTP-Rt_2^{nd}, TTP-Rt_4^{th} Each TTP estimate is a scalar value representing an estimated time for one reference plane to pass or cross the other. Thus, for example, TTP-Ft_1⁴ represents an expected time for the front plane 36 of the host vehicle 12 to pass the plane of the first surface 44 of the detected object 34.

Referring again to the flowchart in FIG. 6, and with continued reference to FIG. 7, at step 108b conditions relating to the TTP estimates are evaluated to determine if there is a potential for collision between the host vehicle 12 and the detected object 34, and if so, the type of collision. There are certain conditions upon which there is no likely collision to occur between the host vehicle 12 and the detected object 34. For example, given a scenario as in FIG. 7 where the detected object 34 is generally in front of, and to the right of, the host vehicle 12, if the estimated time for the rear surface of the host vehicle 12 to pass the third surface of the detected object 34 (i.e., TTP-Rr_3^{rd}) is less than the estimated time for the right-side of the host vehicle 12 to pass the second surface of the detected object 34 (i.e., TTP-Rt_4^{th}), then there is no collision likely as the rear of the host vehicle 12 will clear the detected object 34 before the lateral planes intersect. Those skilled in the art recognize similar no collision conditions for detected objects that are positioned to the front and left of the host vehicle 12, as well as objects positioned to the rear of the host vehicle 12 on either the left or right side.

At step 108c, the types of potential collisions are determined based on the TTP estimates. By way of example, collisions between the detected object 34 and the front of the host vehicle 12 (i.e. a front collision) are determined likely to occur when the front surface of the host vehicle 12 will cross the nearest parallel surface of the detected object 34 after a side surface of the host vehicle 12 crosses the nearest lateral plane (i.e., nearest plane of the detected object that is parallel to the side surface plane of host vehicle) of the detected object 34, but before the other far side surface of the host vehicle 12 will cross the furthest lateral plane of the detected object. Stated another way, a front collision occurs when the time expected for the front plane 36 of the host vehicle 12 to cross the plane of the nearest parallel surface of the detected object 34 is greater than the time expected for a side surface plane of the host vehicle 12 to cross the plane of the nearest side surface of the detected object 34, but less than the time expected for the opposite far side surface plane of the host vehicle 12 to cross the plane of the furthest side surface of the detected object 34.

Using a specific example and with reference to the scenario shown in FIG. 7, a potential collision occurs between the detected object 34 and the front of the host vehicle 12 (i.e., front collision) when the time expected for the front plane 36 of the host vehicle 12 to cross the plane of the nearest parallel surface 44 of the detected object 34 (i.e., TTP-Ft_1^{st}) is greater than the time expected for the right-side plane 42 of the host vehicle 12 to cross the nearest parallel plane 46 of the detected object 34 (i.e., TTP-Rt_2^{nd}), but less than the time expected for the left-side plane 40 of the host vehicle 12 to cross the furthest parallel plane 50 of the detected object 34 (i.e., TTP-Rt_4^{th}). This relationship is represented mathematically as, TTP-Rt_2^{nd}<TTP-Ft_1^{st}<TTP-Lt_4^{th}.

The collision assessments relative to the front, rear, and side surfaces of the host vehicle 12, and in particular, the TTP estimate conditions for determining the type of collision with respect to the host vehicle 12, are summarized in the table below.

| Host Vehicle Front Collision | Host Vehicle Rear Collision |
|---|---|
| TTP-Rt_2^{nd} < TTP-Ft_1^{st} < | TTP-Rt_2^{nd} < TTP-Rr_1^{st} < TTP-Lt_4^{th} |
| TTP-Lt_4^{th} | |
| TTP-Lt_2^{nd} < TTP-Ft_1^{st} < | TTP-Lt_2^{nd} < TTP-Rr_1^{st} < TTP-Rt_4^{th} |
| TTP-Rt_4^{th} | |
| Host Vehicle | |
| Left-Side Collision | Host Vehicle Right-Side Collision |
| TTP-Ft_3^{rd} > TTP-Lt_2^{nd} > | TTP-Ft_3^{rd} > TTP-Rt_2^{nd} > TTP-Ft_1^{st} |
| TTP-Ft_1^{st} | |
| TTP-Rr_3^{rd} > TTP-Lt_2^{nd} > | TTP-Rr_3^{rd} > TP-Rt_2^{nd} > TTP-Rr_1^{st} |
| TTP-Rr_1^{st} | |

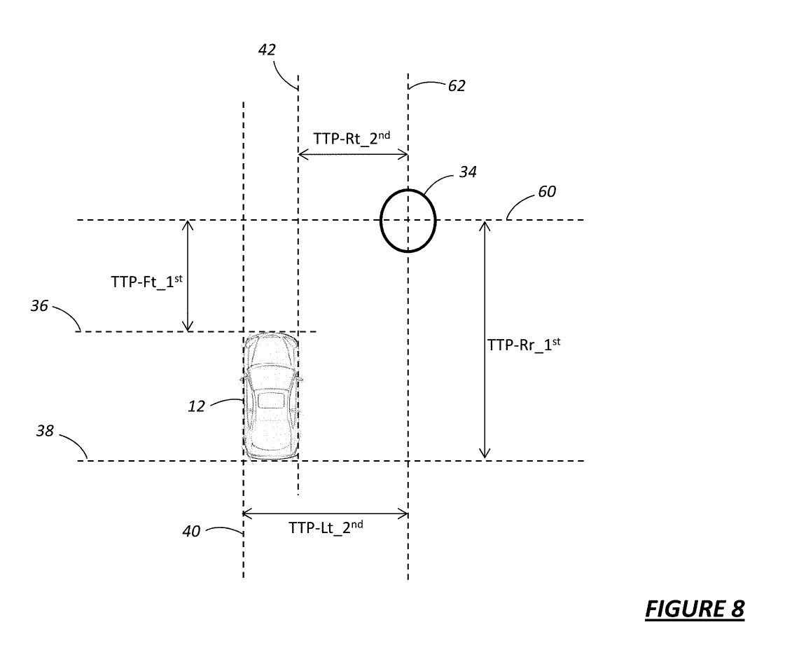

One of ordinary skill in the art appreciates that the reference frames described above with respect to FIG. 7 are merely exemplary and for purposes of explaining the collision assessment method of step 108. For example, while the previously embodiments are described with reference to a detected object 34 having four surfaces, wherein each reference plane represents a distinct surface, one of ordinary skill in the art appreciates that the detected object may not be defined by four surfaces, but rather a point having two intersecting planes. In this case, as illustrated in FIG. 8, the reference planes for the detected object 34 include only a first plane 60 and a second plane 62, wherein the first plane 60 is parallel to the front and rear planes 36, 38 of the host vehicle 12, and the second plane 62 is parallel to the left-side and right-side 40, 42 planes of the host vehicle 12. Thus, in accordance with the disclosed method, the TTP estimates are calculated using only the first and second planes of the detected object 34, as shown in the table below.

| Host Vehicle Front Collision | Host Vehicle Rear Collision |
|---|---|
| TTP-Rt_2^{nd} < TTP-Ft_1^{st} < | TTP-Rt_2^{nd} < TTP-Rr_1^{st} < TTP-Lt_2^{nd} |
| TTP-Lt_2^{nd} | |
| TTP-Lt_2^{nd} < TTP-Ft_1^{st} < | TTP-Lt_2^{nd} < TTP-Rr_1^{st} < TTP-Rt_2^{nd} |
| TTP-Rt_2^{nd} | |
| Host Vehicle | |
| Left-Side Collision | Host Vehicle Right-Side Collision |
| TTP-Rr_1^{st} > TTP-Lt_2^{nd} > | TTP-Rt_2^{nd} > TTP-Rt_2^{nd} > TTP-Ft_1^{st} |
| TTP-Ft_1^{st} | |
| TTP-Ft_1^{st} > TTP-Lt_2^{nd} > | TTP-Ft_2^{nd} > TTP-Rt_2^{nd} > TTP-Rr_1^{st} |
| TTP-Rr_1^{st} | |

Referring back to FIG. 5, at step 112, the time-to-collision for the highest threat object is compared to a braking action threshold. If the time-to-collision for the highest threat object is less than or equal to the braking action threshold, at step 114 a command to decelerate and stop the vehicle is sent to an electronic brake control module (not shown). In one embodiment, the rate of deceleration is determined based on current sensor readings and/or a calibration table stored in the EOCM 18 or the brake control module. Thereafter, the process returns to step 102 to continually check if the remedial action and/or external conditions have changed. If the time-to-collision for the highest threat object at step 112 is not less than or equal to the braking action threshold, at step 116 the time-to-collision for the highest threat object is compared to a steering action threshold.

If the time-to-collision for the highest threat object is less than or equal to the steering action threshold, at step 118 the system determines a steering maneuver to avoid the collision with the highest threat object. The steering maneuver is determined in part based on the relationship between the position, movement, and trajectory of both the vehicle 12 and the detected object. In one embodiment, step 118 may also include sending a brake pulse command as a haptic indicator to the driver prior to commanding the steering maneuver. Prior to initiating the calculated steering maneuver, at step 120 the system evaluates the vehicle's new trajectory to determine if any objects are in the new path of the vehicle 12. If there are objects in the new path that continue to pose a potential for collision, the process returns to step 114 and initiates an emergency braking feature by sending a command to the electronic brake control module to decelerate and stop the vehicle. If there are no objects in the new path, then at step 122 a steering request command is sent to a power steering module (not shown) to execute the steering maneuver to avoid the collision. Thereafter, the process returns to step 102 to continually check if the remedial action and/or external conditions have changed.

Referring back to step 116, if the time-to-collision for the highest threat object is not less than or equal to the steering action threshold, at step 124 the time-to-collision for the highest threat object is compared to a warning action threshold. If the time-to-collision for the highest threat object is less than or equal to the warning action threshold, at step 126 an alert is sent to the instrument panel cluster (not shown) warning the vehicle occupants of the potential collision. The alert can be, without limitation, a message via the instrument panel cluster, audible alerts, haptic alerts, and/or brake pulses.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for use with a vehicle collision system, the method comprising the steps of:
detecting one or more object(s) in a host vehicle's field-of-view;
calculating time-to-pass estimates for each of the detected object(s), wherein the time-to-pass estimates represent an expected time for a reference plane of the host vehicle to pass a reference plane of the detected object(s); and
determining a potential collision between the host vehicle and the one or more detected object(s) based on the time-to-pass estimates.

2. The method of claim 1, wherein calculating the time-to-pass estimates includes calculating time-to-pass estimates for each reference plane of the host vehicle relative to reference planes for each of the one or more detected object(s).

3. The method of claim 2, wherein calculating the time-to-pass estimates for each reference plane of the host vehicle relative to each of the one or more detected object(s) includes calculating time-to-pass estimates between the host vehicle reference planes and corresponding parallel reference planes for each of the one or more detected object(s).

4. The method of claim 1, further including determining a type of potential collision based on the time-to-pass estimates.

5. The method of claim 1, wherein the host vehicle includes a front reference plane, a rear reference plane, a left-side reference plane, and a right-side reference plane, each of which correspond respectively to a front, rear, left-side, and right-side surface of the host vehicle.

6. The method of claim 5, wherein the reference planes for the one or more detected object(s) include a first-surface plane, a second-surface plane, a third-surface plane, and a fourth-surface plane, each of which correspond respectively to a first, second, third, and fourth peripheral surface for each of the one or more detected object(s).

7. The method of claim 6, wherein the front plane and rear plane of the host vehicle are parallel to the first-surface and third-surface planes of each of the one or more detected object(s), and the left-side plane and the right-side plane of the host vehicle are parallel to the second-surface and fourth-surface planes of each of the one or more detected object(s).

8. The method of claim 7, further including determining a potential for a collision between a front surface of the host vehicle and each of the one or more detected object(s) based on:
a time-to-pass estimate between the front plane of the host vehicle and the first-surface plane of each detected object, wherein the first-surface plane of each detected object is closer to the front plane of the host vehicle than to the third-surface plane of each detected object;
a time-to-pass estimate between the second-surface plane of each detected object(s) and a closest of either the left-side plane or the right-side plane of the host vehicle; and
a time-to-pass estimate between the fourth-surface plane of each detected object(s) and a furthest of either the left-side plane or the right-side plane of the host vehicle.

9. The method of claim 8, further including detecting a front collision relative to the host vehicle when the time-to-pass between the front plane of the host vehicle and the first-surface plane of the detected object(s) is greater than the time-to-pass between the second-surface plane of each detected object(s) and the closest of the left-side plane or the right-side plane of the host vehicle, but less than the time-to-pass between the fourth-surface plane of each detected object(s) and the furthest of the left-side plane or the right-side plane of the host vehicle.

10. The method of claim 7, further including a potential for a collision between a rear surface of the host vehicle and each of the one or more detected object(s) based on:
a time-to-pass estimate between the rear plane of the host vehicle and the first-surface plane of each detected object, wherein the first-surface plane of each detected object is closer to the rear plane of the host vehicle than to the third-surface plane of each detected object;
a time-to-pass estimate between the second-surface plane of each detected object and a closest of either the left-side plane or the right-side plane of the host vehicle; and
a time-to-pass estimate between the fourth-surface plane of each detected object and a furthest of either the left-side plane or the right-side plane of the host vehicle.

11. The method of claim 10, further including detecting a rear collision relative to the host vehicle when the time-to-pass between the rear plane of the host vehicle and the first-surface plane of the detected object(s) is greater than the time-to-pass between the second-surface plane of each detected object(s) and the closest of the left-side plane or the right-side plane of the host vehicle, but less than the time-to-pass between the fourth-surface plane of each detected object(s) and the furthest of the left-side plane or the right-side plane of the host vehicle.

12. The method of claim 7, further including determining a potential for a collision between a right-side surface of the host vehicle and each of the one or more detected object(s) based on:
a time-to-pass estimate between the right-side plane of the host vehicle and the second-surface plane of each detected object, wherein the second-surface plane of each detected object is closer to the right-side plane of the host vehicle than to the fourth-surface plane of each detected object;
a time-to-pass estimate between the first-surface plane of each detected object and a closest of either the front plane or the rear plane of the host vehicle;
a time-to-pass estimate between the third-surface plane of each detected object and a furthest of either the front plane or the rear plane of the host vehicle.

13. The method of claim 12, further including detecting a right-side collision relative to the host vehicle when the time-to-pass between the right-side plane of the host vehicle and the second-surface plane of the detected object(s) is greater than the time-to-pass between the first-surface plane of each detected object(s) and the closest of the front plane or the rear plane of the host vehicle, but less than the time-to-pass between the third-surface plane of each detected object(s) and the furthest of the front plane or the rear plane of the host vehicle.

14. The method of claim 14, further including determining a potential for a collision between a left-side surface of the host vehicle and each of the one or more detected object(s) based on:
a time-to-pass estimate between the left-side plane of the host vehicle and the second-surface plane of each detected object, wherein the second-surface plane of each detected object is closer to the left-side plane of the host vehicle than the fourth-surface plane of each detected object;
a time-to-pass estimate between the first-surface plane of each detected object and a closest of either the front plane or the rear plane of the host vehicle;
a time-to-pass estimate between the third-surface plane of each detected object and a furthest of either the front plane or the rear plane of the host vehicle.

15. The method of claim 14, further including detecting a left-side collision relative to the host vehicle when the time-to-pass between the left-side plane of the host vehicle and the second-surface plane of the detected object(s) is greater than the time-to-pass between the first-surface plane of each detected object(s) and the closest of the front plane or the rear plane of the host vehicle, but less than the time-to-pass between the third-surface plane of each detected object(s) and the furthest of the front plane or the rear plane of the host vehicle.

16. A method for use with a vehicle collision system, the method comprising the steps of:
detecting at least one object in a host vehicle's field-of-view;
calculating an expected host vehicle path relative to the at least one detected object; and
determining a potential for a collision between the at least one detected object and a front, rear, left-side, or right-side of the host vehicle, wherein the potential for collision is based on the expected host vehicle path and an intersection of reference planes relating to the host vehicle and the at least one detected object.

17. The method of claim 16, wherein a front reference plane and a rear reference plane of the host vehicle are parallel to a first reference plane of the at least one detected object, and a left-side reference plane and a right-side reference plane of the host vehicle are parallel to a second reference plane of the at least one detected object, and wherein determining the potential for collision further includes:
determining a potential for a front collision between the host vehicle and the at least one detected object when the front plane of the host vehicle crosses the first reference plane of the detected object after the second reference plane of the detected object crosses a nearest of either the left-side reference plane or the right-side reference plane of the host vehicle, but before the second reference plane of the detected object crosses a furthest of either the left-side reference plane or the right-side reference plane of the host vehicle;
determining a potential for a rear collision between the host vehicle and the at least one detected object when the rear plane of the host vehicle crosses the first reference plane of the detected object after the second reference plane of the detected object crosses a nearest of either the left-side reference plane or the right-side reference plane of the host vehicle, but before the second reference plane of the detected object crosses a furthest of either the left-side reference plane or the right-side reference plane of the host vehicle;
determining a potential for a left-side collision between the host vehicle and the at least one detected object when the left-side plane of the host vehicle crosses the second reference plane of the detected object after the first reference plane of the detected object crosses a nearest of either the front reference plane or the rear reference plane of the host vehicle, but before the first reference plane of the detected object crosses a furthest of either the front reference plane or the rear reference plane of the host vehicle; and
determining a potential for a right-side collision between the host vehicle and the at least one detected object when the right-side plane of the host vehicle crosses the second reference plane of the detected object after the first reference plane of the detected object crosses a nearest of either the front reference plane or the rear reference plane of the host vehicle, but before the first reference plane of the detected object crosses a furthest of either the front reference plane or the rear reference plane of the host vehicle.

18. A vehicle collision system, the system comprising:
a plurality of sensors configured to identify one or more objects in a host vehicle's field-of-view; and
a control module configured to:
calculate time-to-pass estimates for each of the detected object(s), wherein the time-to-pass estimates represent an expected time for a reference plane of the host vehicle to pass a reference plane of the detected object(s); and
determine a potential collision between the host vehicle and the one or more detected object(s) based on the time-to-pass estimates.

19. The vehicle collision system of claim 18, wherein the time-to-pass estimates include time-to-pass estimates for each reference plane of the host vehicle relative to corresponding parallel reference planes for each of the one or more detected object(s).

20. The vehicle collision system of claim 18, wherein a front reference plane and a rear reference plane of the host vehicle are parallel to a first reference plane for each of the one or more detected object(s), and a left-side reference plane and a right-side reference plane of the host vehicle are parallel to a second reference plane of the at least one detected object, and wherein control module is further configured to:
determine a potential for a front collision between the host vehicle and the at least one detected object when the front plane of the host vehicle crosses the first reference plane of the detected object after the second reference plane of the detected object crosses a nearest of either the left-side reference plane or the right-side reference plane of the host vehicle, but before the second reference plane of the detected object crosses a furthest of either the left-side reference plane or the right-side reference plane of the host vehicle;
determine a potential for a rear collision between the host vehicle and the at least one detected object when the rear plane of the host vehicle crosses the first reference plane of the detected object after the second reference plane of the detected object crosses a nearest of either the left-side reference plane or the right-side reference plane of the host vehicle, but before the second reference plane of the detected object crosses a furthest of either the left-side reference plane or the right-side reference plane of the host vehicle;
determine a potential for a left-side collision between the host vehicle and the at least one detected object when the left-side plane of the host vehicle crosses the second reference plane of the detected object after the first reference plane of the detected object crosses a nearest of either the front reference plane or the rear reference plane of the host vehicle, but before the first reference plane of the detected object crosses a furthest of either the front reference plane or the rear reference plane of the host vehicle; and
determine a potential for a right-side collision between the host vehicle and the at least one detected object when the right-side plane of the host vehicle crosses the second reference plane of the detected object after the first reference plane of the detected object crosses a nearest of either the front reference plane or the rear reference plane of the host vehicle, but before the first reference plane of the detected object crosses a furthest of either the front reference plane or the rear reference plane of the host vehicle.
